(19) United States
(12) Patent Application Publication
(10) Pub. No.: US 2026/0249124 A1
(43) Pub. Date: Aug. 27, 2026

(54) PULSE FLOW REACTORS AND SYSTEMS OR USES THEREOF

(71) Applicant: THERMOCHEM RECOVERY INTERNATIONAL, INC., Baltimore, MD (US)

(72) Inventors: Ravi Chandran, Baltimore, MD (US); Timothy R. Swanson, Baltimore, MD (US)

(21) Appl. No.: 19/650,136

(22) Filed: Apr. 16, 2026

Related U.S. Application Data
(63) Continuation of application No. PCT/US2024/051575, filed on Oct. 16, 2024.
(60) Provisional application No. 63/544,435, filed on Oct. 16, 2023.

(51) Int. Cl. A62D 3/38; A62D 101/02; A62D 101/22; B01D 53/68; B01D 53/76

(52) U.S. Cl. CPC A62D 3/38; B01D 53/68; B01D 53/76; A62D 2101/02; A62D 2101/22; B01D 2257/20; B01D 2257/93; B01D 2258/02

(57) ABSTRACT

A pulse flow reactor including an air plenum configured to receive an oxidant, an aerovalve configured to receive the oxidant from the air plenum, a combustion chamber configured to receive the oxidant from the aerovalve and to receive a target material to be combusted, an injector coupled to the combustion chamber and configured to provide the target material to the combustion chamber, and a tailpipe through which combustion products from the combustion chamber exit the pulse flow reactor. The oxidant is in the form of a gas, and the target material comprises a liquid or slurry or vapor. Destroying or combusting a target material includes providing the target material to the pulse flow reactor, providing an oxidant to the combustion chamber, and thermally or thermochemically treating the target material in the combustion chamber to combust the target material, thereby yielding combustion products.

### CROSS-REFERENCE TO RELATED APPLICATION

This application is a continuation application of PCT Application No. PCT/US2024/051575 filed Oct. 16, 2024, which claims the benefit of U.S. Patent Application No. 63/544,435, filed on Oct. 16, 2023, which is incorporated herein by reference in its entirety.

### TECHNICAL FIELD

The present document relates to pulse flow reactors including a combustion chamber. Systems and uses thereof are also provided.

### BACKGROUND

Pulse combustion is characterized by high combustion intensity, high combustion efficiency, and low emissions. Pulse combustors are generally configured to combust gaseous fuels and, in some cases, solid fuels such as micronized or pulverized coals.

### SUMMARY

The present document relates to a pulse flow reactor configured to thermally or thermochemically process or otherwise destroy or render harmless a target material (e.g., an unwanted chemical or waste material). In some non-limiting embodiments, the target material includes a toxicant, a toxic waste, a chemical warfare agent (CWA), a biological warfare agent (BWA), per- and polyfluoroalkyl substances (PFAS), refrigerants, halogenated liquids or vapors, or other undesired chemicals.

Although the disclosed inventive concepts include those defined in the attached claims, it should be understood that the inventive concepts can also be defined in accordance with the following embodiments.
Embodiment 1 is pulse flow reactor comprising:
an air plenum configured to receive an oxidant, wherein the oxidant is in the form of a gas;
an aerovalve configured to receive the oxidant from the air plenum;
a combustion chamber configured to receive the oxidant from the aerovalve and to receive a target material to be combusted;
an injector coupled to the combustion chamber and configured to provide the target material to the combustion chamber, wherein the target material comprises a liquid or slurry or vapor; and
a tailpipe through which combustion products from the combustion chamber exit the pulse flow reactor.
Embodiment 2 is the pulse flow reactor of embodiment 1, further comprising an atomizer in fluidic communication with the air plenum, the aerovalve, or the combustion chamber, wherein the atomizer is configured to receive the target material and to provide a plurality of droplets comprising the target material to the air plenum, the aerovalve, or the combustion chamber, respectively.
Embodiment 3 is the pulse flow reactor of embodiment 2, wherein the atomizer is coupled to an exterior of the air plenum, the aerovalve, or the combustion chamber.
Embodiment 4 is the pulse flow reactor of embodiment 2, wherein the atomizer positioned at least partially within the air plenum, the aerovalve, or the combustion chamber.
Embodiment 5 is the pulse flow reactor of any one of embodiments 1-4, further comprising a fuel inlet configured to accept auxiliary or startup fuel and fluidly coupled to the combustion chamber.
Embodiment 6 is the pulse flow reactor of any one of embodiments 1-5, further comprising a vaporizer in heat transfer communication with the tailpipe, wherein the vaporizer is configured to generate a vapor from the target material.
Embodiment 7 is the pulse flow reactor of embodiment 6, wherein the vaporizer is electrically heated or heated by process heat.
Embodiment 8 is the pulse flow reactor of any one of embodiments 1-7, wherein the at least one aerovalve comprises a headpiece, and the headpiece comprises a chamber defining:
a first portion comprising a spraying zone for the target material; and
a second portion comprising a mixing and vaporizing zone configured to mix and vaporize the spray.
Embodiment 9 is the pulse flow reactor of embodiment 8, further comprising an air transfer conduit or an aerovalve disposed between the first portion and the second portion of the chamber.
Embodiment 10 is the pulse flow reactor of embodiment 9, wherein the second portion of the chamber is configured to be positioned around or in proximity to the combustion chamber.
Embodiment 11 is the pulse flow reactor of embodiment 10, wherein the second portion of the chamber is a portion of the combustion chamber.
Embodiment 12 is the pulse flow reactor of any one of embodiments 1-11, further comprising one or more atomizers coupled to the air plenum and configured to receive the target material, wherein each atomizer comprises a nozzle configured to provide a plurality of droplets comprising the target material to the air plenum.
Embodiment 13 is the pulse flow reactor of any one of embodiments 1-12, further comprising one or more inlets configured to deliver a fuel, an oxidant, or both to the combustion chamber.
Embodiment 14 is the pulse flow reactor of any one of embodiments 1-13, further comprising one or more injectors configured to deliver a fuel, an oxidant, or both to the combustion chamber.
Embodiment 15 is the pulse flow reactor of any one of embodiments 1-14, further comprising one or more ignitors configured to provide a spark to the combustion chamber.
Embodiment 16 is the pulse flow reactor of any one of embodiments 1-15, wherein the combustion chamber defines a mixing and vaporizing zone and a combusting zone.
Embodiment 17 is the pulse flow reactor of any one of embodiments 1-16, wherein the pulse flow reactor defines a spraying zone, a mixing and vaporizing zone, and a combusting zone.
Embodiment 18 is the pulse flow reactor of any one of embodiments 1-17, wherein the tailpipe comprises a conical, diverging section.
Embodiment 19 is the pulse flow reactor of embodiment 18, wherein the tailpipe further comprises a straight tubular section.
Embodiment 20 is the pulse flow reactor of any one of embodiments 18 or 19, wherein the tailpipe further comprises a curved tubular section.
Embodiment 21 is the pulse flow reactor of any one of embodiments 1-20, further comprising one or more additional air plenums, aerovalves, injectors, or tailpipes, or any combination thereof.
Embodiment 22 is a system comprising one or more of the pulse flow reactors of any one of embodiments 1-21.
Embodiment 23 is a method of destroying or combusting a target material, the method comprising:
providing the target material to a pulse flow reactor comprising a combustion chamber, wherein the target material comprises a liquid;
providing an oxidant to the combustion chamber; and
thermally or thermochemically treating the target material in the combustion chamber to combust the target material, thereby yielding combustion products.
Embodiment 24 is the method of embodiment 23, wherein the target material is in the form of a vapor, a slurry, or droplets.
Embodiment 25 is the method of embodiment 23 or 24, wherein the oxidant comprises air, enriched air, oxygen, steam and carbon dioxide, or a mixture thereof.
Embodiment 26 is the method of any one of embodiments 23-25, wherein the target material comprises a toxicant, a toxic waste, a chemical warfare agent (CWA), a biological warfare agent (BWA), a per- and/or polyfluoroalkyl substance (PFAS), a refrigerant, a halogenated liquid or vapor, or any combination thereof.
Embodiment 27 is the method of any one of embodiments 23-26, wherein a destruction and removal efficiency of the target material is at least 99%.

Other features and advantages of the present document will be apparent from the following detailed description, the figures, and the claims.

### BRIEF DESCRIPTION OF THE DRAWINGS

The following drawings illustrate certain embodiments of the features and advantages of this document. These embodiments are not intended to limit the scope of the appended claims in any manner.

FIGS. 1A-1D depict a non-limiting embodiment of a pulse flow reactor. FIG. 1A is a perspective view of the pulse flow reactor. FIG. 1B is a side view along the line labeled B-B in FIG. 1A. FIG. 1C is a cross-sectional view along the line labeled C-C in FIG. 1A. FIG. 1D is a close-up view within the dashed box in FIG. 1C.

FIGS. 2A-2B depict another non-limiting embodiment of a pulse flow reactor. FIG. 2A is a perspective view of the pulse flow reactor. FIG. 2B is a side view along the line labeled B-B in FIG. 2A. FIG. 2C is a top view of the pulse flow reactor. FIG. 2D is a close-up view of the air plenum and combustion chamber of the pulse flow reactor.

FIGS. 3A-3D depict another non-limiting embodiment of a pulse flow reactor. FIG. 3A is a perspective view of the pulse flow reactor. FIG. 3B is a side view along the line labeled B-B in FIG. 3A. FIG. 3C is a top view of the pulse flow reactor. FIG. 3D is a close-up view of the air plenum, aerovalves, atomizer and combustion chamber of the pulse flow reactor.

FIGS. 4A-4B depict a non-limiting embodiment of a pulse flow reactor with an integral vaporizer. FIG. 4A is a side view of the reactor. FIG. 4B is a cross-sectional view along the line labeled B-B in FIG. 4A.

FIGS. 5A-5D depict another non-limiting embodiment of a pulse flow reactor. FIG. 5A is a side view of the pulse flow reactor. FIG. 5B is a cross-sectional view along the line labeled B-B in FIG. 5A. FIG. 5C is a cross-sectional view along line labeled C-C in FIG. 5B. FIG. 5D is a close-up view of a non-limiting fuel injection head.

FIGS. 6A-6B depict a non-limiting embodiment of a pulse flow reactor with an integral vaporizer. FIG. 6A is a side view of the reactor. FIG. 6B is a cross-sectional view along line labeled B-B in FIG. 6A. FIGS. 6C-6D depict another non-limiting embodiment of an aerovalve body. FIGS. 6C and 6D are side and perspective views, respectively, of the aerovalve body.

FIGS. 7A-7E depict another non-limiting embodiment of a pulse flow reactor with an aerovalve assembly having an aerovalve headpiece. FIG. 7A is a perspective view of the pulse flow reactor. FIG. 7B is a top view of the pulse flow reactor. FIG. 7C is an aerovalve assembly. FIG. 7D is an aerovalve headpiece. FIG. 7E is a cross-sectional view along the line labeled E-E in FIG. 7D.

FIGS. 8A-8G depict a non-limiting embodiment of a pulse flow reactor. FIG. 8A is a perspective view of the pulse flow reactor. FIG. 8B is a side view of the pulse flow reactor. FIG. 8C is a bottom view of the pulse flow reactor. FIG. 8D is a cross-sectional view along the line labeled D-D in FIG. 8C. FIG. 8E is a detail view of the circled portion in FIG. 8D. FIG. 8F is a perspective view of the combustion chamber. FIG. 8G is a cross-sectional view along the line labeled G-G in FIG. 8F.

### DETAILED DESCRIPTION

This disclosure describes pulse flow reactors for combustion of target materials: unwanted chemicals and waste materials that are hazardous, have a high boiling point, a low flash point, a high viscosity, and/or act as a fire retardant, etc. In some embodiments, the pulse flow reactor is configured to thermochemically process or otherwise destroy or render harmless a target material. The pulse combustors described herein are configured to operate as chemical reactors (e.g., pulse flow reactors) to accept such wastes, react, and destroy the hazardous components at very high efficiency. Since the characteristic time constants (mixing time, reaction time) associated with pulse combustion are very short (<1 to 10 milliseconds), pulse combustors described herein are configured for rapid vaporization and mixing of the unwanted chemicals or waste materials with an oxidant (e.g., air). In some non-limiting embodiments, the pulse flow reactor is characterized by a destruction and removal efficiency (DRE) exceeding 90% (e.g., greater than 91%, 92%, 93%, 94%, 95%, 96%, 97%, 98%, 99%, 99.5%, 99.9%, 99.99%, 99.999%, 99.9999% or greater).

Without wishing to be limited by mechanism or theory, the pulse flow reactors described herein can operate like a two-stroke engine with the sequential steps of air/fuel intake, compression, ignition/combustion, expansion, and recharge. These steps can be repeated in a cyclic fashion at a selected design frequency. Fuel and air pass into the combustion chamber through an aerovalve or a non-mechanical valve, which operates like a fluidic diode with lower flow resistance for forward flow of target material into the combustion chamber but higher resistance for the reverse flow of combustion products. The mixture of target material and oxidant can then self-compress, self-ignite, and combust, generating a pressure wave that travels down the tailpipe (e.g., exhaust tube or resonance tube). The force of the wave and the inertia of the gases in the exhaust tube can create a partial vacuum within the combustion chamber, drawing in air and target material for the next cycle. The pressure wave can be partially reflected back down the tailpipe, resulting in increased pressure of the gas in the combustion chamber, where the fresh mixture of target material and oxidant can ignite due at least in part to the pressure and temperature from the hot gases of the preceding cycle. The process can then be repeated (e.g., indefinitely), while being controlled by acoustic and thermodynamic laws. This design is based on the Helmholtz resonator principle. Typical, non-limiting design frequency ranges from 20 to 300 Hz and more typically between 40 and 200 Hz. While air is commonly the oxidant, in some applications enriched air, oxygen, steam, and carbon dioxide or a mixture thereof may be utilized as the oxidant. While the Figures that follow provide descriptions based on air as the oxidant, other gases and/or vapors may be utilized as oxidant. In some embodiments, the pulse flow reactor herein is configured to destroy the liquid-containing target material in the form of a liquid, a slurry, or a vapor.

In some embodiments, the pulse flow reactor includes one or more of the following: an air plenum, one or more injectors or one or more vaporizers or one or more atomizers, one or more aerodynamic air inlet valves or aerovalves, one or more startup or auxiliary fuel injectors, a combustion chamber, and one or more tailpipes or resonance tubes.

Different configurations or embodiments are envisioned depending upon the location of the waste injector(s) or atomizer(s) relative to the air plenum, aerovalve(s), and combustion chamber. The reactor geometry, size, design frequency, type, number, and location of waste injector(s) or atomizer(s), number of aerovalves and number of tailpipes, and the materials of construction can be selected based on factors such as characteristics of the target material (e.g., chemistry, physical, chemical, and thermodynamic properties), desired throughput, the target DRE, etc.

The pulse flow reactor can optionally include an atomizer or a vaporizer, which can be internally or externally located. For example, and without limitation, the pulse flow reactor can include an internal atomizer or vaporizer configured to provide a dispersion or a vapor including droplets of a target material to be processed within the reactor. In another non-limiting example, the pulse flow reactor can include an external atomizer or vaporizer configured to deliver a dispersion or vapor into a chamber of the reactor. Any useful atomizer or vaporizer can be employed. Non-limiting examples of atomizers include a gas-assisted or air-assisted atomizer, an acoustic atomizer, an atomizer with air bubbling, an ultrasonic atomizer, a pneumatic atomizer, a rotary atomizer, a mechanical atomizer, a hydraulic atomizer, and the like, which can include one or more gas or air inlets to facilitate droplet formation. The atomizer includes any type, such as, e.g., a dual fluid type (e.g., external mix, internal mix or ultrasonic, other) or in some instances a single fluid type (e.g., high pressure spray, ultrasonic, etc.). The vaporizer, for example, may be an annulus around part of the tailpipe with a liquid inlet and vapor outlet wherein the tailpipe provides the heat from the flue gas to the liquid in the annulus to vaporize it. Other vaporizer arrangements may include coils or membrane walls around the combustion chamber and/or tailpipe(s), tubes carrying liquid exposed to the flue gas either in the tailpipe(s) or downstream of tailpipe(s), external heat exchangers, electric heaters, and the like.

Furthermore, one or more atomizers may be employed. For example, and without limitation, a plurality of atomizers (e.g., atomizer nozzles) can be arranged on a plate, which in turn can be attached to an inlet of a pulse flow reactor. The plurality of atomizers can be arranged in any useful array or other configuration (e.g., a hexagonal array, a circular pattern, staggered array, in-line array, and the like). In some embodiments, the plurality of atomizers can be configured to provide a spray pattern configured to provide uniform distribution and/or effective combustion within the combustion chamber.

Without wishing to be limited by mechanism or theory, the use of an atomizer can facilitate dispersion of a liquid-containing target material (e.g., a liquid or slurry). Dispersion can be achieved at ambient pressure or processing pressure within the pulse flow reactor. By forming fine droplets of the liquid-containing target material, the surface area per unit volume or mass increases significantly, and in turn the gas-droplet interaction for heat and mass transfer and kinetics; this shortens the vaporization and reaction times and thermochemical processing (e.g., by way of combustion) can be performed within a residence time that allows for sufficient mixing, compression, ignition, expansion, and/or reflux of the target material and its combustion products within the chamber(s) of the reactor. Depending on the target material (e.g., vapor pressure, phase, content, etc.) and initial conditions (e.g., temperature, pressure, vacuum, etc.), atomization may be useful (e.g., when the target material will maintain its liquid phase during initiation of the combustion reaction) or may be avoided (e.g., when the target material will be in a vapor or gas phase during initiation of the combustion reaction).

In some embodiments, the pulse flow reactor can include an air plenum configured to provide main air to the pulse flow reactor. The air serves as the oxidant for the combustion of the target material. In some embodiments, air can be provided as an atomization fluid to promote atomization of the target material into a fine dispersion. In some embodiments, the one or more atomizers are fluidically coupled to the air plenum (e.g., directly connected to the air plenum).

In some embodiments, the pulse flow reactor can include one or more outlet ports configured to deliver fuel, target material, oxidant, or other reactive component to the aerovalve, the combustion chamber, or both.

In some embodiments, the pulse flow reactor can include one or more fuel injectors configured to deliver fuel to the aerovalve and/or the combustion chamber.

In some embodiments, the system includes one or more atomizers and a pulse flow reactor, wherein at least one atomizer is positioned at least partially or completely within the pulse flow reactor and configured to be in fluidic communication with an aerovalve of the pulse flow reactor.

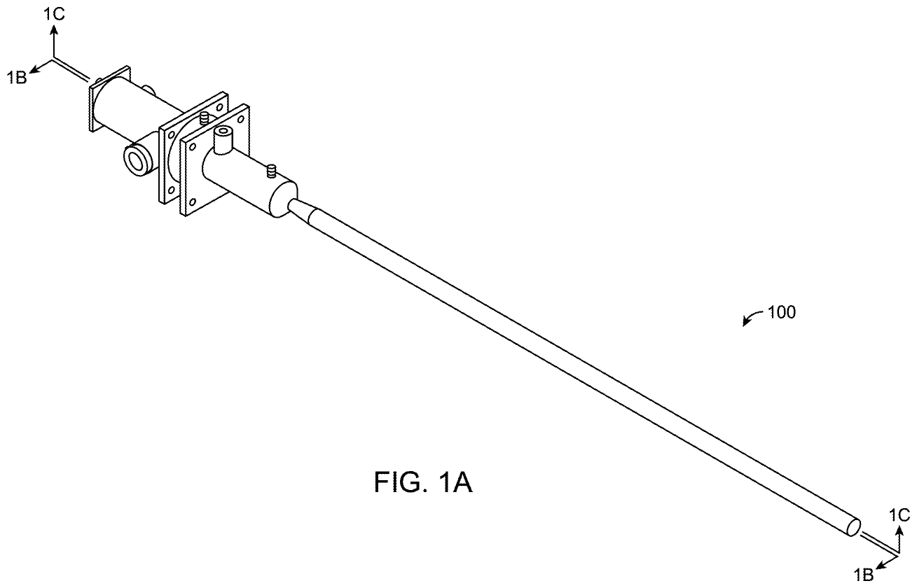

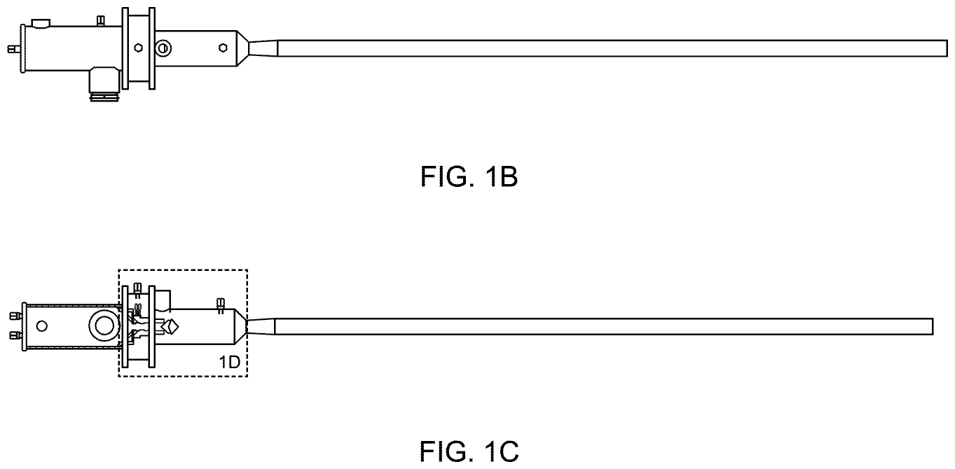

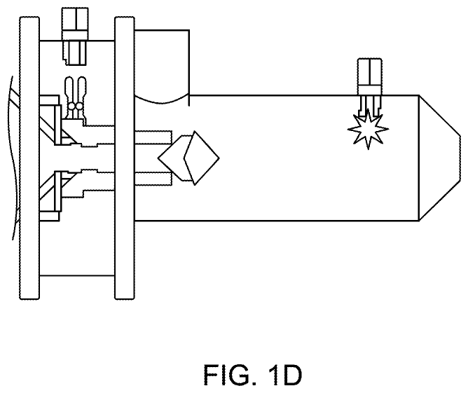

FIGS. 1A-1D provides a non-limiting pulse flow reactor 100. Here, main air is delivered to the air plenum, which in turn delivers the air to one or more components in the pulse flow reactor 100. The aerovalve operates like a fluidic diode or non-mechanical valve that provides air for combustion with limited or low backflow of flue gases into the air plenum. It may also include a fuel injection head to facilitate mixing of auxiliary or startup fuel such as propane.

As depicted in FIGS. 1A-1C, the pulse flow reactor 100 includes an air plenum 102 with inlet 104 for main air, aerovalve 106 with inlet 108 for startup/auxiliary fuel, combustion chamber 110 with inlet 112 for target material, and tailpipe 114. Aerovalve 106 is in fluidic communication with the air plenum 102 and the combustion chamber 110. Air plenum 102 is configured to receive main air through inlet 104. Aerovalve 106 is configured to receive startup/auxiliary fuel through inlet 108. Combustion chamber 110 is configured to receive target material (e.g., in atomized or vapor form) through inlet 112. The target material is processed (e.g., combusted) in the combustion chamber 110, and the reaction products exit the pulse flow reactor 100 through tailpipe 114.

In some cases, as depicted in FIG. 1A, pulse flow reactor 100 includes ignitor 116 coupled to combustion chamber 110. In some cases, as depicted in FIGS. 1C and 1D, pulse flow reactor 100 includes atomizer 118 fluidically coupled to combustion chamber 110.

As depicted in FIG. 1D, the aerovalve 106 is coupled to a fuel injection head 120, which is positioned in the combustion chamber 110. Air can be delivered (e.g., by way of the air plenum 102) and through the aerovalve 106. Optionally, startup fuel or an auxiliary fuel can be provided to the fuel injector 120 to initiate the combustion process, as described herein. The auxiliary or startup fuel can be provided to a region in proximity to the fuel injector 120. Within this region, fuel and air and the target material converge to provide the components to initiate and sustain a combustion reaction. In some embodiments, the flow of air and flow of target material are optimized to promote mixing and combustion.

In some embodiments, a flow direction of air is generally orthogonal or perpendicular to a flow direction of the target material. Other geometries and configurations, as well as other operating conditions, can be implemented to promote mixing (e.g., turbulent mixing) between air, the target material, fuel, oxidant, and the like and/or to minimize backflow of target material (e.g., into the air plenum and/or the atomizer), combustion products (e.g., into the aerovalve), fuel (e.g., into the fuel inlet or fuel transfer conduit), oxidants (e.g., into the oxidant inlet or oxidant transfer conduit), and the like. Optionally, an ignitor 116 can be coupled to the combustion chamber to provide a spark. In some embodiments, the ignitor 116 can include an ignitor input configured to provide an ignitor fuel and/or an ignitor oxidant.

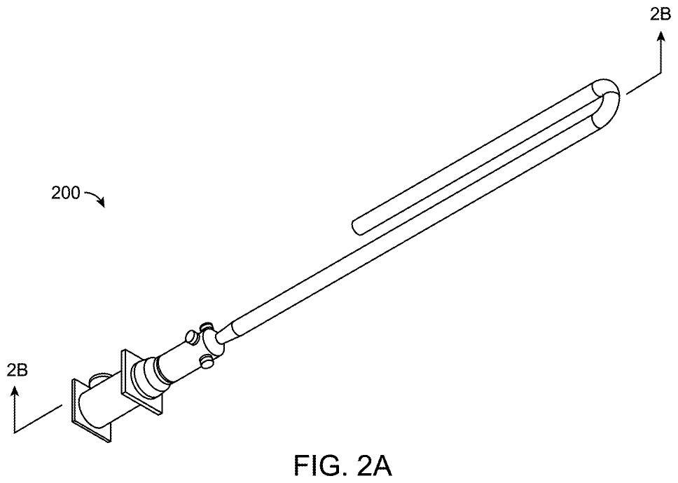

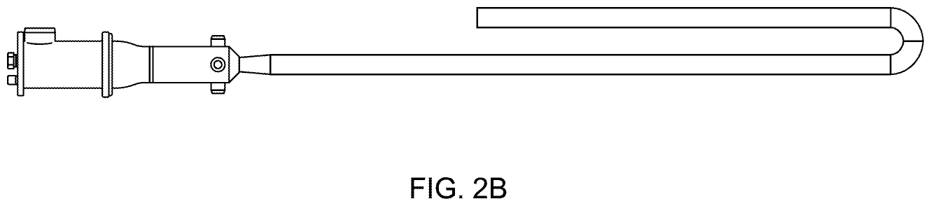

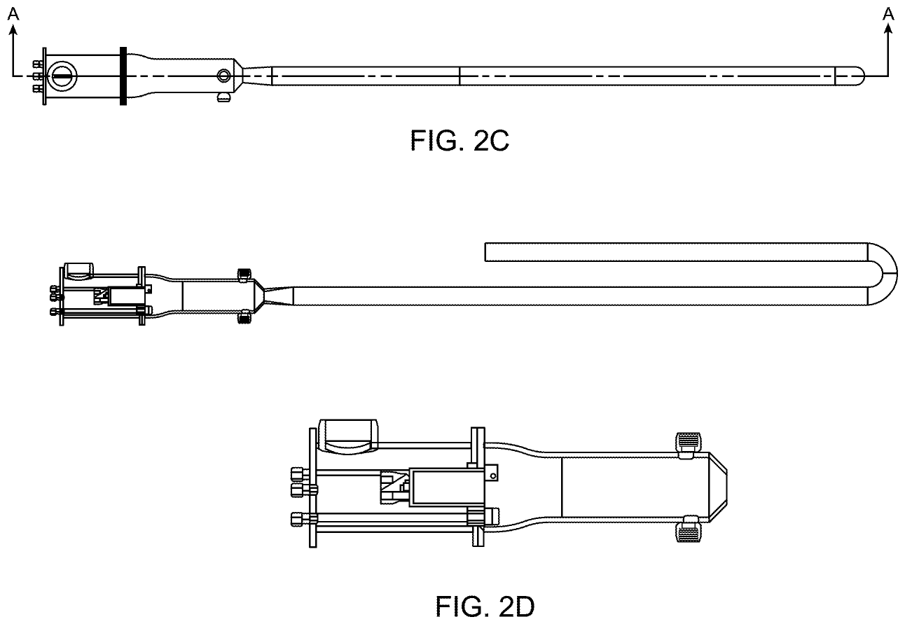

As depicted in FIGS. 2A-2C, the pulse flow reactor 200 includes an air plenum 202 configured to receive and deliver air (e.g., main air by way of inlet 204), one or more aerovalves 206, one or more auxiliary/startup fuel injectors 220, as well as to receive and deliver the target material; a combustion chamber 210 configured for combustion of the target material to form one or more combustion products; and a tailpipe 214 configured to transport the one or more combustion products away from the combustion chamber 210. Here, the upstream portion of the combustion chamber 210 can be enlarged to accommodate multiple (e.g., 3 or 4 or more) aerovalves 206 which surround the one or more atomizers 218 at the center. As can be depicted, the tailpipe 214 can have any useful geometry and/or configuration such as straight cylinder (e.g., tube), a curved or U-shaped cylinder (e.g., tube) or U-bend, or a combination thereof. The U-bend may comprise preferably long radius 90-degree elbows or in some cases 90-degree short radius elbows. In some embodiments, the tailpipe 214 can include a curved or curvilinear configuration. Such a configuration may, for instance, minimize size (e.g., footprint) of the reactor (or a system including such a reactor) for enhanced portability.

The target material can be provided by way of an inlet 212 in proximity to the air plenum 202. As depicted in FIG. 2D, an atomizer 218 is positioned in air plenum 202 and in fluidic communication with the inlet 212, thereby providing the target material in atomized or vaporized form to the combustion chamber 210. Optionally, the air plenum 202 may further include an atomizer air inlet 222 configured to provide air to the atomizer 218. Optionally, the pulse flow reactor 200 can include one or more ignitors 216 (e.g., any described herein).

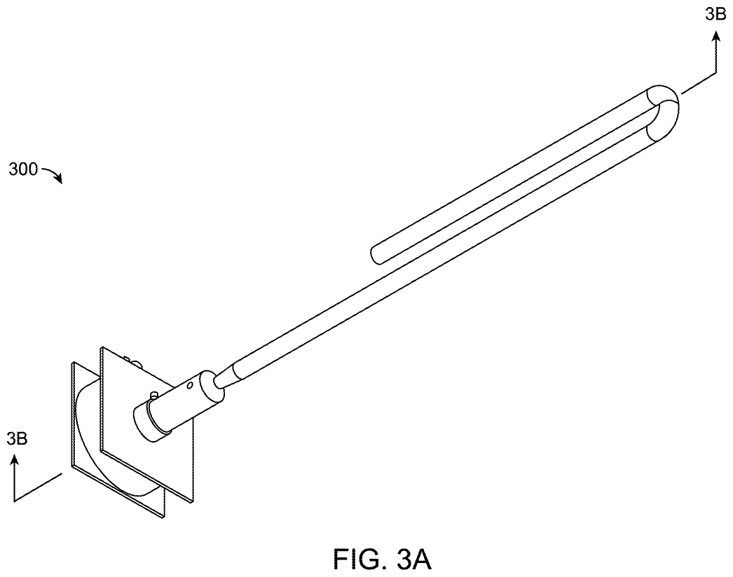

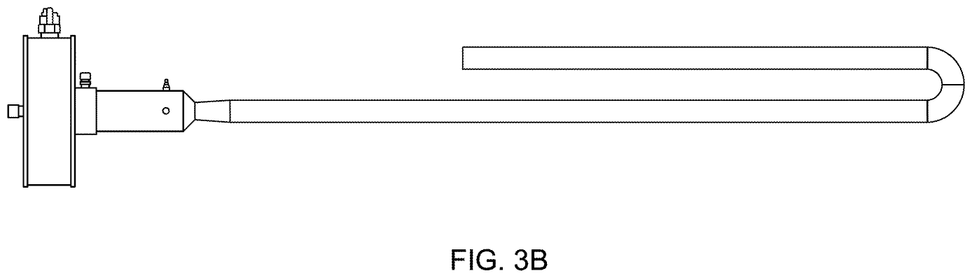

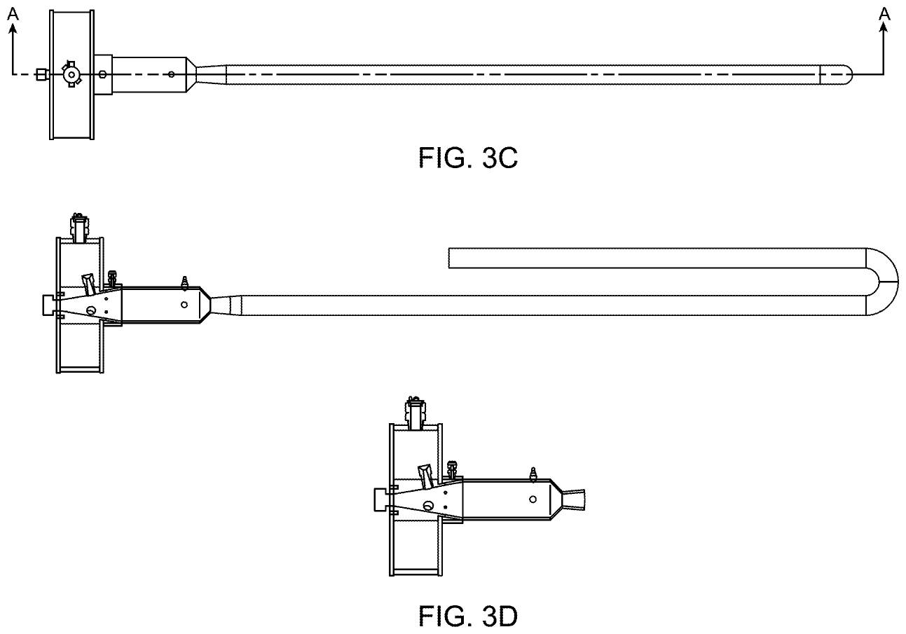

As depicted in FIG. 3A-3D, the pulse flow reactor 300 can include: an atomizer 318 (e.g., target material injector) configured to receive and deliver the target material to a mixing or vaporizing zone 324; an air plenum 302 configured to receive and deliver air (e.g., main air by way of inlet 304), one or more aerovalves 306 in communication with the air plenum 302; ; one or more auxiliary/startup fuel injectors 320; a conical or diverging section 326 to vaporize droplets of the target material and mix with air; a converging section 330; combustion chamber 310 configured to compress, ignite, and combust the target material to yield one or more combustion products; and a tailpipe 314 configured to transport the one or more combustion products away from the combustion chamber 310. In some embodiments, the air plenum 302 is configured to couple to an atomizer 318. In this way, the atomizer can provide a liquid-containing target material into the combustion chamber 310. By providing the target material as a plurality of droplets (e.g., a plurality of liquid droplets dispersed in a gas), enhanced mixing, compression, and combustion can be observed. Optionally, the pulse flow reactor 300 can include one or more ignitors 316 (e.g., any described herein).

For example and without limitation, air can be injected into the aerovalve 306, in which the direction of injected air can be generally orthogonal or perpendicular to a direction of target material being sprayed into the mixing/vaporization zone 324.

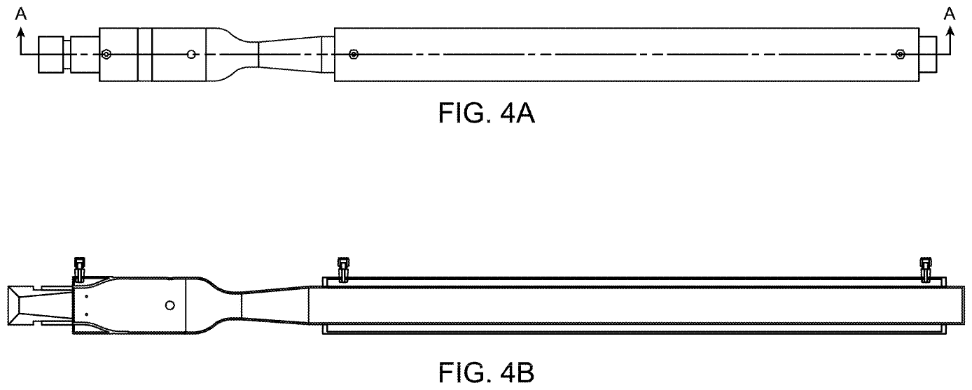

As depicted in FIGS. 4A-4B, pulse flow reactor 400 includes an integral vaporizer to vaporize the target material for feeding into the pulse flow reactor. Pulse flow reactor 400 has a double pipe configuration with outer shell 432 and tailpipe 414. Outer shell 432 functions as a vaporizer. Tailpipe 414 functions as an inner shell for flue gas flow and the annulus for the target material to flow into and vaporize. Pulse flow reactor 400 has a similar configuration as a gas-fired pulse combustor with aerovalve 406, combustion chamber 410, tailpipe 414, one or more auxiliary/startup fuel injectors 420, a conical or diverging section 426 to vaporize droplets of the target material and mix with air, and a converging section 430. An air plenum (not depicted) may be included. In some cases, an external heat exchanger may be utilized as a vaporizer. The external heat exchanger may be heated electrically or by process heat (e.g., steam).

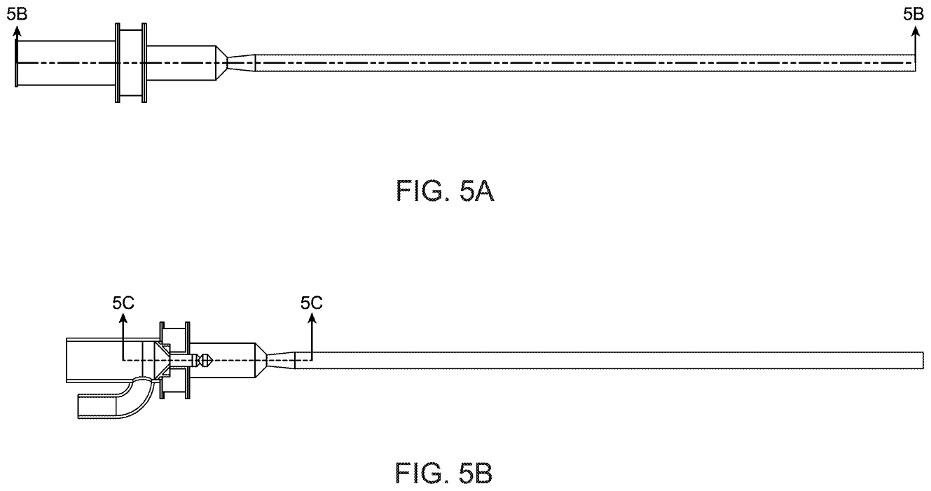

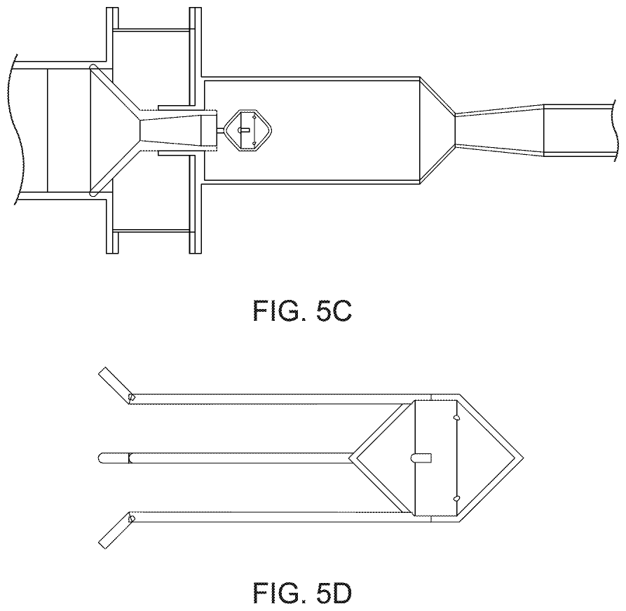

As depicted in FIGS. 5A-5D, the pulse flow reactor 500 includes an air plenum 502 configured to receive and deliver air (e.g., main air by way of inlet 504), as well as to receive target material (e.g., from an atomizer); an aerovalve 506 configured to receive air from the air plenum 502 and the target material; a combustion chamber 510 for combustion of the target material; and a tailpipe 514 configured to transport the combustion products away from the combustion chamber 510. In some embodiments, the air plenum 502 is configured to couple to an atomizer. The aerovalve 506 provides a fluidic diode that receives the target material and main air and provides these to the combustion chamber 510. The aerovalve 506 can be configured to provide such flow to the combustion chamber 510 (e.g., by use of structures to provide desired or optimal flow profiles, pressure gradients, etc.) and/or to provide further components that facilitate mixing and vaporizing of the target material. As depicted in FIG. 5C, the aerovalve 506 may include a first inner conical surface 536, a second inner conical surface 538, and a fuel injection head 520. The aerovalve 506 may include one or more auxiliary or startup fuel transfer conduits 540 configured to provide auxiliary or startup fuel to the fuel injector distributor 542 configured to provide fuel to the fuel injection head. The auxiliary or startup fuel outlet port(s) 544 can be arranged in any useful manner within the fuel injection head 520. The aerovalve 506 in conjunction with the fuel injection head 520 directs the atomized droplets or vapor of the target material and the main air radially to mix and/or vaporize.

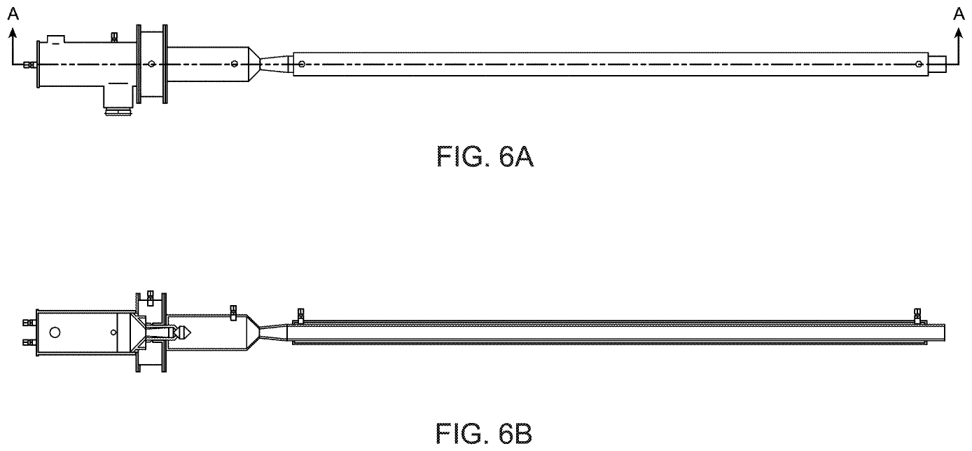

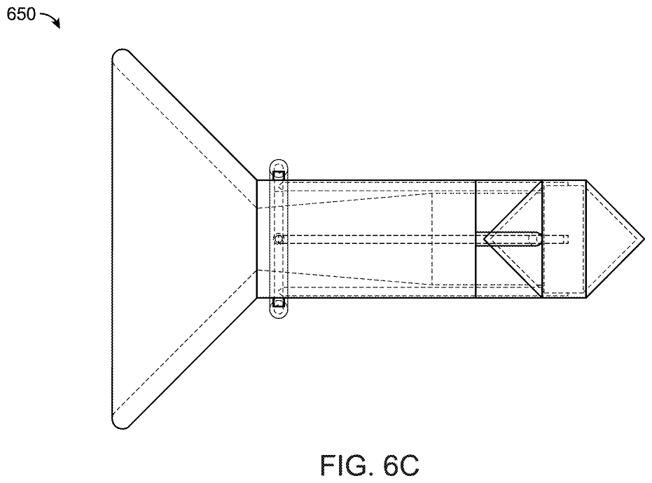

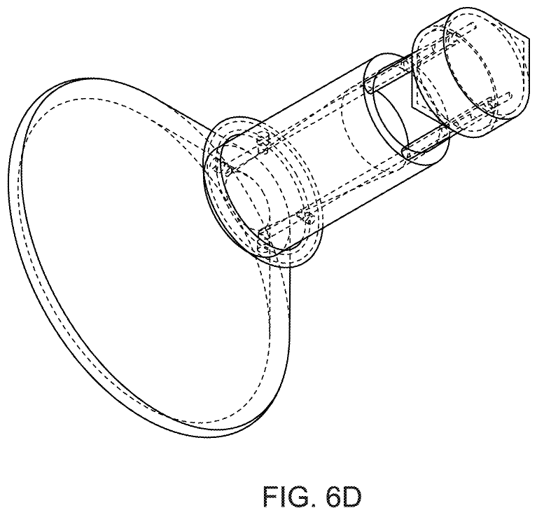

As depicted in FIG. 6A-6D, pulse flow reactor 600 includes an integral vaporizer to vaporize the target material for feeding into the pulse flow reactor. The integral vaporizer has a double pipe configuration, with outer shell 632 that functions as a vaporizer and tailpipe 614 that functions as an inner shell for flue gas flow and the annulus for the target material to flow into and vaporize. The pulse flow reactor 600 has an aerovalve assembly 646, combustion chamber 610, and tailpipe 614. An air plenum 602 may be included. In some cases, an external heat exchanger may be utilized as vaporizer. The external heat exchanger may be heated electrically or by process heat (e.g., steam). The aerovalve assembly 646 includes an aerovalve body 648 and a fuel plenum or manifold 650 with a fitting configured to input a gas (auxiliary or startup fuel) and/or vapor. As depicted in FIG. 6C, the aerovalve body 648 includes a first inner conical surface 636, a second inner conical surface 638, a fuel transfer conduit 640, and a fuel injection head 620. The aerovalve body 648 further includes an inlet 652 in proximity to the first inner conical surface 636 and an outlet 654 in proximity to the second inner conical surface 638. The inlet 652 is configured to receive the main air, and the outlet 654 is configured to deliver the air and target material vapor into the combustion chamber 610. The aerovalve body 648 can include a fuel injection head 620 configured to reduce backflow (e.g., of the combustion products) into the aerovalve 606. The fuel injection head 620 can include a plate having conical or curved surfaces (e.g., bilateral surfaces) configured to promote flow and mixing of target material vapor and main air into the combustion chamber, while minimizing backflow of combustion products into the aerovalve. The fuel injection head 620 can include additional components such as fuel distributor and a reservoir or capacitance for fuel.

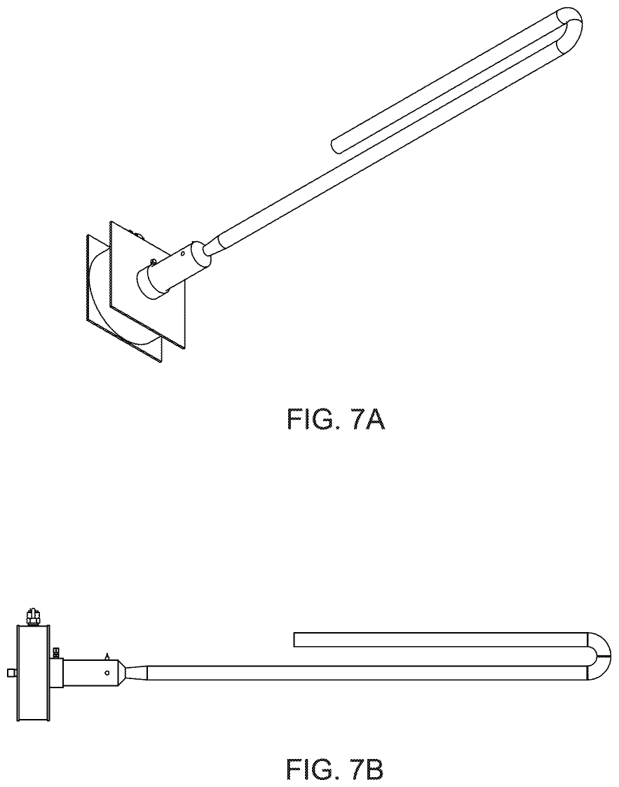

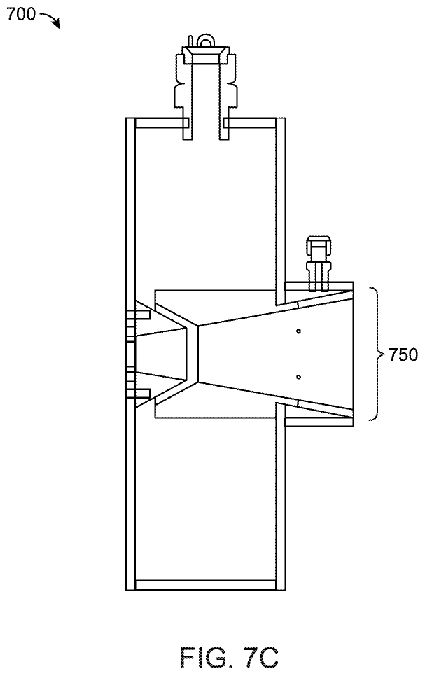

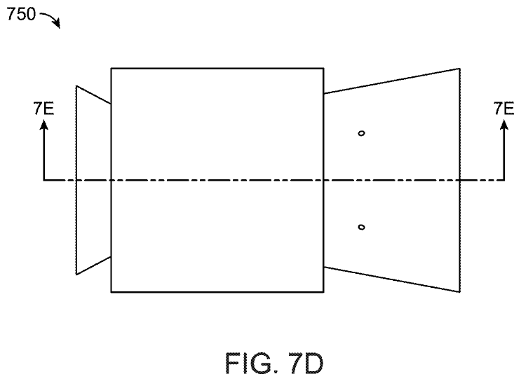

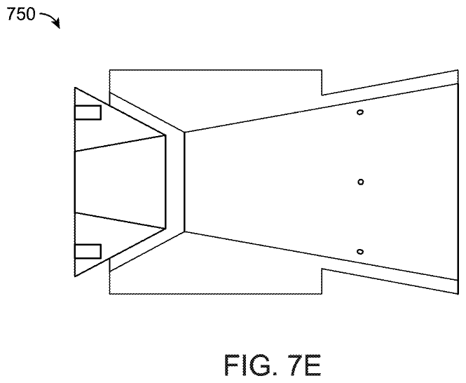

FIGS. 7A-7E depict a pulse flow reactor 700 with an aerovalve assembly 746 having an aerovalve headpiece 756. The pulse flow reactor 700 can include: an atomizer 718 (e.g., target material injector) configured to receive and deliver the target material to a mixing or vaporizing zone 764; an air plenum 702 configured to receive and deliver air (e.g., main air by way of inlet 704); one or more auxiliary/startup fuel injectors 720; combustion chamber 710 configured to compress, ignite, and combust the target material to yield one or more combustion products; and a tailpipe 714 configured to transport the one or more combustion products away from the combustion chamber 710. The aerovalve headpiece 756 has one or more auxiliary/startup fuel injectors 720, a third inner conical surface 758 and a fourth inner conical surface 760. Optionally, the pulse flow reactor 700 can include one or more ignitors 716 (e.g., any described herein). Various zones within the aerovalve headpiece 756 may be present, including a spraying zone 762, a mixing and vaporizing zone 764, and an air transfer conduit 766 disposed between the two zones. Herein, the air transfer conduit 766 functions like an aerovalve. For small systems or in the case of low target material throughput, a radial circumferential slot or passage as depicted may be adequate. For large systems or for high target material throughput, this air transfer conduit 766 for main air should be configured as a circumferential aerovalve (see FIG. 7E), with the third inner conical surface 758, the fourth inner conical surface 760, and an orifice 768 disposed between these surfaces. The aerovalve headpiece 756 can include an inlet 770 in proximity to the third inner conical surface 758 and an outlet 772 in proximity to the fourth inner conical surface 760. The inlet 770 is configured to receive the target material (e.g., as a spray and/or from the atomizer) into the spraying zone 762, and the outlet 772 is configured to receive and mix the target material in the mixing and vaporizing zone 764, as well as to deliver the target material into the combustion chamber. The tapped holes 774 may be used, in some embodiments, to couple to one or more atomizers.

Any useful combustion chamber may be employed. In some embodiments, the combustion chamber is in fluidic communication with an air plenum (e.g., configured to provide a target material to a mixing and vaporizing zone of the combustion chamber). In some embodiments, the combustion chamber is in fluidic communication with an aerovalve (e.g., configured to provide a target material in the spraying zone and deliver the target material as a spray into a mixing and vaporizing zone of the combustion chamber).

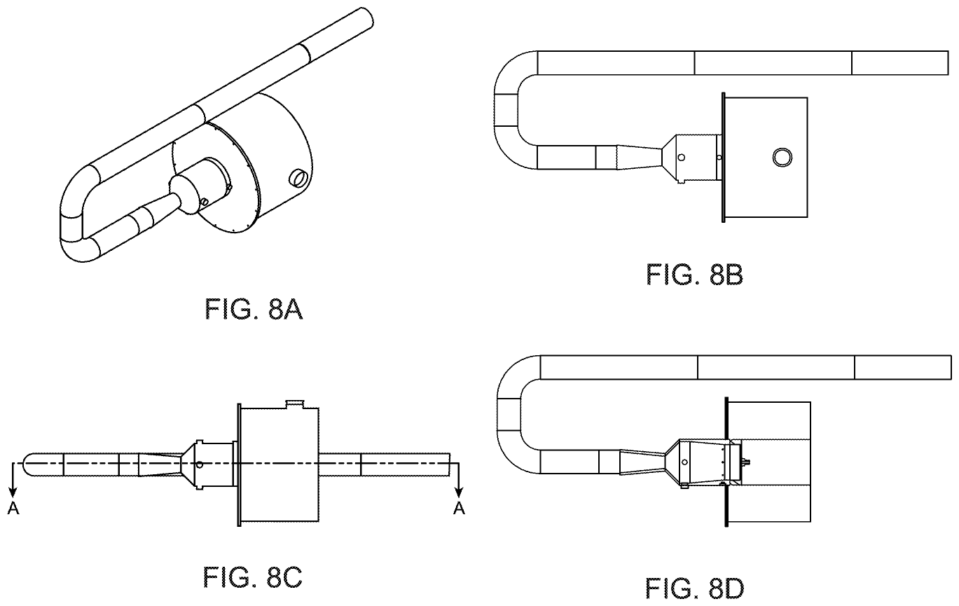

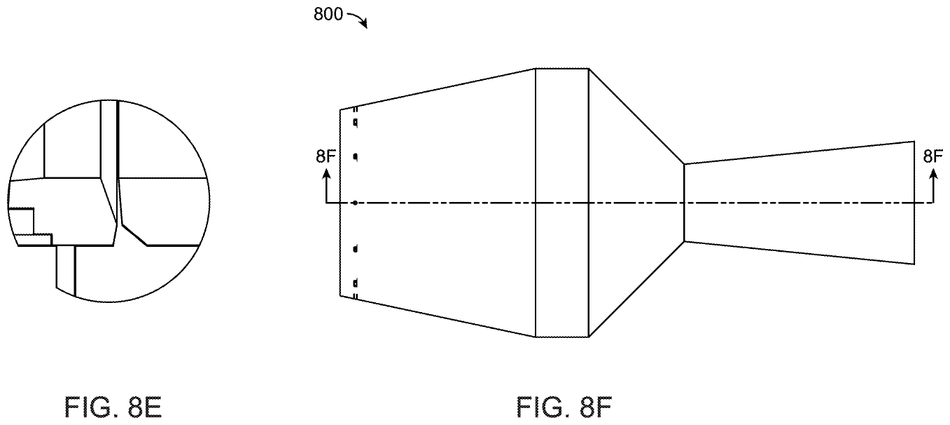

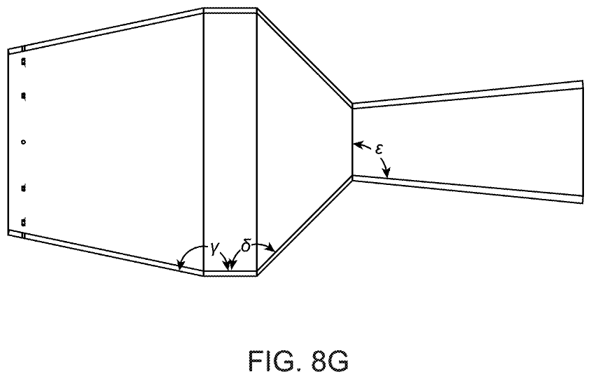

As depicted in FIGS. 8A-8G, the pulse flow reactor 800 comprises an air plenum 802, one or more atomizers 818, radial/circumferential aerovalve 806, combustion chamber 810, and one or more tailpipes 814. The combustion chamber 810 can include a mixing and vaporizing zone 864 and a combusting zone 876. Within the mixing and vaporizing zone 864, the target material is received. Optionally, one or more fuel injectors 820 are positioned in the mixing and vaporizing zone 864. In some embodiments, the mixing and vaporizing zone 864 includes one or more auxiliary or startup fuel outlets configured to provide fuel to the combustion chamber 810. The mixing and vaporizing zone 864 can be configured to facilitate fluidic flow of target material from the spraying zone 862 inside the aerovalve headpiece 856 into the mixing and vaporizing zone 864. As depicted, the mixing and vaporizing zone 864 can include a fifth inner conical surface 878 configured to provide useful flow profiles, flow properties, and the like. The combustion chamber 810 can include a combusting zone 876 (e.g., including a sixth inner surface 880 and a seventh inner conical surface 882). The angles between the surface (e.g., angles γ, β, and ε) can be optimized to provide desired flow profiles and properties during introduction of the target material into the combustion chamber 810 and/or during pulsatile flow of the combustion products and/or during transport of combustion products to the tailpipe 814. As depicted in FIG. 8G, tailpipe 814 can include an eighth inner conical surface 884. Other geometric configurations (e.g., angles, diameters, flanges, tapering or expanding of surfaces or profiles along a longitudinal axis, flanges, etc.) are encompassed by the present document.

The present document also encompasses a system including a pulse flow reactor (e.g., any described herein). In some embodiments, the system includes one or more atomizers and a pulse flow reactor, wherein at least one atomizer is external to the pulse flow reactor and the pulse flow reactor is configured to be coupled to the at least one atomizer. In some embodiments, at least one aerovalve of the pulse flow reactor is configured to be coupled to the at least one atomizer.

Further non-limiting embodiments of pulse combustion heat exchangers, pulse combustors, aerovalves, thermochemical processing (e.g., of a reactive material or other chemicals), systems thereof, and methods thereof are described in U.S. Pat. Nos. 7,531,014 and 10,215,401, each of which is incorporated herein by reference in its entirety.

### Methods

The present document encompasses methods of using a pulse flow reactor (e.g., any described herein). In some embodiments, the method includes use of a pulse flow reactor to thermally or thermochemically process a target material including a chemical or waste (e.g., any described herein). In some embodiments, the chemical or waste is in gas form, liquid form, solid form, vapor form or a combination thereof. In some embodiments, the chemical or waste is in liquid form that is provided as a plurality of dispersed liquid droplets (e.g., fine liquid droplets). In some embodiments, the chemical or waste is in slurry form that is provided as a plurality of dispersed droplets, which in turn can include liquids and/or solids.

### Chemical or Waste

The present document encompasses a pulse flow combustor, as well as systems including such a component or uses of such a component, for thermochemically process or otherwise destroy or render harmless a chemical or waste. The chemical or waste can be in any form, including gas, liquid, or solid form, as well as combination or mixtures thereof (e.g., in vapor form, slurry form, particulate form, and the like).

In some non-limiting embodiments, the chemical or waste includes a toxicant, a toxic waste, a chemical warfare agent (CWA), a biological warfare agent (BWA), a per- and polyfluoroalkyl substance (PFAS), a refrigerant, halogenated liquid or vapor or another undesired chemical. Non-limiting examples of chemicals and waste include one or more of the following: organophosphorous agents (e.g., an organophosphate agent), including but not limited to tabun (GA), sarin (GB), chlorosarin (GC), soman (GD), chlorosoman, ethylsarin (GE), cyclosarin (GF), 2-(dimethylamino)ethyl N, N-dimethylphosphoramidofluoridate (GV), diisopropylfluorophosphate (DFP), VR nerve agent (N, N-diethyl-2-(methyl-(2-methylpropoxy)phosphoryl) sulfanylethanamine or R-33), VX nerve agent (O-ethyl S-[2-(diisopropylamino)ethyl] methylphosphonothioate or Venomous Agent X), amitom (VG), 3,3,5-trimethylcyclohexyl 3-pyridyl methylphosphonate (VP), propyl S-2-diisopropylaminoethylmethylphosphonothiolate (EA-1763), O-butyl S-[2-(diethylamino)ethyl] methylphosphonothioate (EA-6043), methoxy-(1-(diethylamino)ethylidene) phosphoramidofluoridate (A-232), ethyl N-[(1E)-1-(diethylamino)ethylidene]-phosphoramidofluoridate (A-234), methyl-(bis(diethylamino) methylene)phosphonamidofluoridate (A-242), methyl paraoxon, ethyl paraoxon, malathion, or methyl parathion; an insecticide, including carbamates or organophosphorous or phosphorothioate agents, such as azamethiphos, azinphos-methyl, chlorpyrifos, coumaphos, cyanophos, demeton, diazinon, dichlorovos, diisopropyl fluorophosphate (DFP), dioxathion, fenitrothion, fonofos, glyphosate, malathion, methamidophos, mevinphos, oxydemeton-methyl, parathion, phosmet, tetrachlorvinphos, and tetraethylpyrophosphate (TEPP); an alkylating agent, (e.g., mustard gas, O-mustard, sesquimustard bis(2-chloroethyl) sulfide, 2-chloroethyl ethyl sulfide, chloromethyl methyl sulfide, and dibromodiethyl sulfide), a toxin, such as, (e.g., a neurotoxin such as botulinum toxin or saxitoxin or tetrodotoxin, an enterotoxin such as staphylococcal enterotoxin B, an exotoxin such as anthrax toxin, a mycotoxin, and a toxalbumin such as ricin), a per- or polyfluoroalkyl substance (PFAS) (e.g., a compound having one or more perfluorinated methyl groups (—CF₃) and/or one or more perfluorinated methylene groups (—CF₂—), e.g., perfluorononanoic acid (PFNA), perfluorooctanesulfonic acid (PFOS), perfluorooctanoic acid (PFOA), perfluorooctanesulfonyl fluoride, perfluorohexanoic acid (PFHxA), perfluorohexanesulfonic acid (PFHxS), and perfluorobutanesulfonic acid (PFBS)), a toxic industrial chemical (e.g., malathion, hydrogen cyanide, sodium cyanide, butyl isocyanate, phosgene gas, phosphine, tetraethyl pyrophosphate, phosphorous trichloride, capsaicin, hydrogen sulfide, carbon disulfide, sulfur dioxide, formaldehyde, ethylene oxide, chlorine gas, anhydrous ammonia gas, methyl bromide, boron trichloride, fluorine, arsine, and tungsten hexafluoride), a radionuclide, a bacterium (e.g., Bacillus (e.g., B. anthracis), Enterobacteriaceae (e.g., Salmonella, Escherichia coli, Yersinia pestis, Klebsiella, and Shigella), Yersinia (e.g., Y. pestis or Y. enterocolitica), Staphylococcus (e.g., S. aureus), Streptococcus, Gonorrheae, Enterococcus (e.g., E. faecalis), Listeria (e.g., L. monocytogenes), Brucella (e.g., B. abortus, B. melitensis, or B. suis), Vibrio (e.g., V. cholerae), Corynebacterium diphtheria, Pseudomonas (e.g., P. pseudomallei or P. aeruginosa), Burkholderia (e.g., B. mallei or B. pseudomallei), Shigella (e.g., S. dysenteriae), Rickettsia (e.g., R. rickettsii, R. prowazekii, or R. typhi), Francisella tularensis, Chlamydia psittaci, Coxiella burnetii, Mycoplasma (e.g., M. mycoides), etc.), an allergen (e.g., peanut dust, mycotoxins, mold spores, or bacterial spores such as Clostridium botulinum and C. perfringens), a virus (e.g., Adenoviridae (e.g., adenovirus), Arenaviridae (e.g., Machupo virus), Bunyaviridae (e.g., Hantavirus or Rift Valley fever virus), Coronaviridae, Orthomyxoviridae (e.g., influenza viruses), Filoviridae (e.g., Ebola virus and Marburg virus), Flaviviridae (e.g., Japanese encephalitis virus and Yellow fever virus), Hepadnaviridae (e.g., hepatitis B virus), Herpesviridae (e.g., herpes simplex viruses), Papovaviridae (e.g., papilloma viruses), Paramyxoviridae (e.g., respiratory syncytial virus, measles virus, mumps virus, or parainfluenza virus), Parvoviridae, Picornaviridae (e.g., polioviruses), Poxviridae (e.g., variola viruses), Reoviridae (e.g., rotaviruses), Retroviridae (e.g., human T cell lymphotropic viruses (HTLV) and human immunodeficiency viruses (HIV)), Rhabdoviridae (e.g., rabies virus), and Togaviridae (e.g., encephalitis viruses, yellow fever virus, and rubella virus))), a protozoon (e.g., Cryptosporidium parvum, Encephalitozoa, Plasmodium, Toxoplasma gondii, Acanthamoeba, Entamoeba histolytica, Giardia lamblia, Trichomonas vaginalis, Leishmania, or Trypanosoma (e.g., T. brucei and T. Cruzi)), a helminth (e.g., such as cestodes (tapeworms), trematodes (flukes), or nematodes (roundworms, e.g., Ascaris lumbricoides, Trichuris trichiura, Necator americanus, or Ancylostoma duodenale)), a parasite (e.g., any protozoa or helminths described herein), a fungus (e.g., Aspergilli, Candidae, Coccidioides immitis, and Cryptococci) a pathogen, an environmental contaminant, a water additive, an agricultural marker, a nucleic acid (e.g., oligonucleotides, polynucleotides, nucleotides, nucleosides, molecules of DNA, or molecules of RNA, including a chromosome, a plasmid, a viral genome, a primer, or a gene); a genetic modification (e.g., antibiotic resistance marker gene), a protein (e.g., a glycoprotein, a metalloprotein, an enzyme, a prion, or an immunoglobulin), a metabolite, a sugar, a lipid, a lipopolysaccharide, a weaponized pathogen (e.g., Bacillus anthracis, Yersinia pestis, Francisella tularensis, Brucella (e.g., B. suis), Burkholderia mallei, Burkholderia pseudomallei, Shigella, Clostridium botulinum, Variola (e.g., V. major), Filoviridae (e.g., Ebola virus and Marburg virus), Arenaviridae (e.g., Lassa virus and Machupo virus), Clostridium perfringens, any food-borne pathogen (e.g., Salmonella species, Escherichia coli O157:H7, or Shigella), Chlamydia psittaci, Coxiella burnetii, Staphylococcal aureus, Rickettsia (e.g., R. prowazekii or R. rickettsii), Alphavirus (e.g., Venezuelan equine encephalitis virus, eastern equine encephalitis virus, or western equine encephalitis virus), Vibrio cholerae, Cryptosporidium parvum, Henipavirus (e.g., Nipah virus), Bunyaviridae (e.g., Hantavirus or Rift Valley fever virus), Flaviviridae (e.g., Japanese encephalitis virus and Yellow fever virus), and Coccidioides spp).

Depending on the target material, varying types and amount of combustion products can be formed. These may include mainly carbon dioxide and water vapor apart from nitrogen and oxygen. Compounds such as CO, CH₄, HCl, SO₂, SO₃, HF, H₃PO₄, H₃PO₃, NOₓ, P₂O₅, etc. may be present depending upon the target material composition. The reactors are advantageously designed to achieve a very high DRE (at least 99.99% and preferably 99.9999% or higher) and thereby minimize the presence of unconverted target material, if any. Typically, the combustion products or flue gas will be routed through a dry or wet scrubber to capture the contaminants such as HCl, SO₂, SO₃, HF, H₃PO₄, H₃PO₃, NOₓ, and P₂O₅. The dry scrubber may utilize sorbents (alkali, calcium-based, iron-based, etc.) and the wet scrubber may utilize reagents (alkali, calcium-based, iron-based, triazine, etc.) or solvents to capture the contaminants.

Although this disclosure contains many specific embodiment details, these should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order depicted or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

What is claimed is:

1. A pulse flow reactor comprising:
an air plenum configured to receive an oxidant, wherein the oxidant is in the form of a gas;
an aerovalve configured to receive the oxidant from the air plenum;
a combustion chamber configured to receive the oxidant from the aerovalve and to receive a target material to be combusted;
an injector coupled to the combustion chamber and configured to provide the target material to the combustion chamber, wherein the target material comprises a liquid or slurry or vapor; and
a tailpipe through which combustion products from the combustion chamber exit the pulse flow reactor.

2. The pulse flow reactor of claim 1, further comprising an atomizer in fluidic communication with the air plenum, the aerovalve, or the combustion chamber, wherein the atomizer is configured to receive the target material and to provide a plurality of droplets comprising the target material to the air plenum, the aerovalve, or the combustion chamber, respectively.

3. The pulse flow reactor of claim 2, wherein the atomizer is coupled to an exterior of the air plenum, the aerovalve, or the combustion chamber.

4. The pulse flow reactor of claim 2, wherein the atomizer positioned at least partially within the air plenum, the aerovalve, or the combustion chamber.

5. The pulse flow reactor of claim 1, further comprising a fuel inlet configured to accept auxiliary or startup fuel and fluidly coupled to the combustion chamber.

6. The pulse flow reactor of claim 1, further comprising a vaporizer in heat transfer communication with the tailpipe, wherein the vaporizer is configured to generate a vapor from the target material.

7. The pulse flow reactor of claim 6, wherein the vaporizer is electrically heated or heated by process heat.

8. The pulse flow reactor of claim 1, wherein the at least one aerovalve comprises a headpiece, and the headpiece comprises a chamber defining:
a first portion comprising a spraying zone for the target material; and
a second portion comprising a mixing and vaporizing zone configured to mix and vaporize the spray.

9. The pulse flow reactor of claim 8, further comprising an air transfer conduit or an aerovalve disposed between the first portion and the second portion of the chamber.

10. The pulse flow reactor of claim 9, wherein the second portion of the chamber is configured to be positioned around or in proximity to the combustion chamber.

11. The pulse flow reactor of claim 10, wherein the second portion of the chamber is a portion of the combustion chamber.

12. The pulse flow reactor of claim 1, further comprising one or more atomizers coupled to the air plenum and configured to receive the target material, wherein each atomizer comprises a nozzle configured to provide a plurality of droplets comprising the target material to the air plenum.

13. The pulse flow reactor of claim 1, further comprising one or more inlets configured to deliver a fuel, an oxidant, or both to the combustion chamber.

14. The pulse flow reactor of claim 1, further comprising one or more injectors configured to deliver a fuel, an oxidant, or both to the combustion chamber.

15. The pulse flow reactor of claim 1, further comprising one or more ignitors configured to provide a spark to the combustion chamber.

16. The pulse flow reactor of claim 1, wherein the combustion chamber defines a mixing and vaporizing zone and a combusting zone.

17. The pulse flow reactor of claim 1, wherein the pulse flow reactor defines a spraying zone, a mixing and vaporizing zone, and a combusting zone.

18. The pulse flow reactor of claim 1, wherein the tailpipe comprises a conical, diverging section.

19. The pulse flow reactor of claim 18, wherein the tailpipe further comprises a straight tubular section.

20. The pulse flow reactor of claim 18, wherein the tailpipe further comprises a curved tubular section.

21. The pulse flow reactor of claim 1, further comprising one or more additional air plenums, aerovalves, injectors, or tailpipes.

22. A method of destroying or combusting a target material, the method comprising:
providing the target material to a pulse flow reactor comprising a combustion chamber, wherein the target material comprises a liquid;
providing an oxidant to the combustion chamber; and
thermally or thermochemically treating the target material in the combustion chamber to combust the target material, thereby yielding combustion products.

23. The method of claim 22, wherein the target material is in the form of a vapor or droplets.

24. The method of claim 22, wherein the oxidant comprises air, enriched air, oxygen, steam and carbon dioxide, or a mixture thereof.

25. The method of claim 22, wherein the target material comprises a toxicant, a toxic waste, a chemical warfare agent (CWA), a biological warfare agent (BWA), a per- and/or polyfluoroalkyl substance (PFAS), a refrigerant, a halogenated liquid or vapor, or any combination thereof.

26. The method of claim 22, wherein a destruction and removal efficiency of the target material is at least 99%.
